(19) United States
(12) Patent Application Publication
(10) Pub. No.: US 2005/0250531 A1
(43) Pub. Date: Nov. 10, 2005

(54) Mobile communication terminal having plurality of operation modes

(75) Inventors: Manabu Takebe, Tachikawa-shi (JP); Masato Hirai, Akishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/948,668

(22) Filed: Sep. 24, 2004

(30) Foreign Application Priority Data
May 10, 2004 (JP) 2004-139907

(51) Int. Cl. H04M 1/00

(52) U.S. Cl. 455/550.1

(57) ABSTRACT

A mobile communication terminal includes a first mode unit which executes a first mode for mobile communication with a base station, a second mode unit which executes a second mode different from the first mode, and a battery which outputs power for operating the first mode unit and the second mode unit. This terminal includes a mode-specific power supply control unit. The mode-specific power supply control unit divides the battery capacity held by the battery into the first and second capacities, and allocates the first and second capacities to the first and second mode units, respectively.

### CROSS-REFERENCE TO RELATED APPLICATIONS

This application is based upon and claims the benefit of priority from prior Japanese Patent Application No. 2004-139907, filed May 10, 2004, the entire contents of which are incorporated herein by reference.

### BACKGROUND OF THE INVENTION

1. Field of the Invention

The present invention relates to a mobile communication terminal, which uses a battery as a power supply and has a plurality of operation modes including a mobile communication mode, like a mobile telephone or personal digital assistant (PDA).

2. Description of the Related Art

Prolonging continuous communication time and standby time poses an important challenge for a mobile communication terminal such as a mobile telephone or PDA as well as decreasing size and weight. Various measures to solve such a challenge have been executed or studied. For example, Jpn. Pat. Appln. KOKAI Publication No. 2001-285190 discloses a technique of monitoring the remaining capacity of a battery in a mobile communication terminal and performing incoming call restriction, transmission control on control signals, reception restriction on control signals, and the like for the terminal stepwise in accordance with a reduction in the remaining capacity. This arrangement makes it possible to perform at least an urgent outgoing call even when the remaining capacity of the battery is low.

An increasing number of mobile communication terminals have various kinds of optional modes in addition to the mobile communication mode. For example, such a mobile telephone has a mode of image-sensing an object by using a camera, a television reception mode of receiving terrestrial broadcasts, a mode of playing back contents such as music and video recorded on a recording medium such as a memory card, and a mode of executing an application program such as a game recorded on a recording medium or downloaded from a Web site age or the like.

Obviously, a mobile communication terminal of this type consumes more power, resulting in a shorter battery life, than a single-function terminal having only the mobile communication mode. For this reason, for example, as the camera mode or content playback mode is used, the battery drains, and communication cannot be performed due to insufficient battery capacity when the user tries to make an outgoing call. In contrast to this, when mobile communication is frequently performed, the battery drains, and the user cannot use the camera mode when he/she needs to use it.

That is, conventional power supply control provided in consideration of only the mobile communication mode described above is an insufficient measure, and hence strong demands have arisen for more effective power supply control measures.

### BRIEF SUMMARY OF THE INVENTION

It is an object of the present invention to provide a mobile communication terminal which can optimize the form of use of battery capacity when a plurality of operation modes are to be selectively used.

In order to achieve the above object, according to an aspect of the present invention, there is provided a mobile communication terminal including a first mode unit which executes a first mode for mobile communication with a base station, a second mode unit which executes a second mode different from the first mode, and a battery which outputs power for operating the first mode unit and the second mode unit, comprising a mode-specific power supply control unit. The mode-specific power supply control unit divides the battery capacity held by the battery into the first and second capacities, and allocates the first and second capacities to the first and second mode units, respectively.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention.

FIG. 1 is a block diagram showing the arrangement of a mobile communication terminal according to the first embodiment of the present invention;

FIG. 2 is a flowchart showing a mode-specific power supply control sequence and its contents in the mobile communication terminal shown in FIG. 1;

FIG. 3 is a flowchart showing a mode-specific power consumption amount measurement control sequence and its contents in the mode-specific power supply control shown in FIG. 2;

FIG. 4 is a flowchart showing an operation termination control sequence and its contents in the mode-specific power supply control shown in FIG. 2;

FIG. 5 is a block diagram showing the arrangement of a mobile communication terminal according to the second embodiment of the present invention;

FIG. 6 is a block diagram showing the arrangement of a mobile communication terminal according to the third embodiment of the present invention;

FIG. 7 is a block diagram showing the arrangement of a mobile communication terminal according to the fourth embodiment of the present invention;

FIG. 8 is a block diagram showing the arrangement of a mobile communication terminal according to the fifth embodiment of the present invention; and

FIG. 9 is a flowchart showing a mode-specific power supply control sequence and its contents in a mobile communication terminal according to the sixth embodiment of the present invention.

### DETAILED DESCRIPTION OF THE INVENTION

### First Embodiment

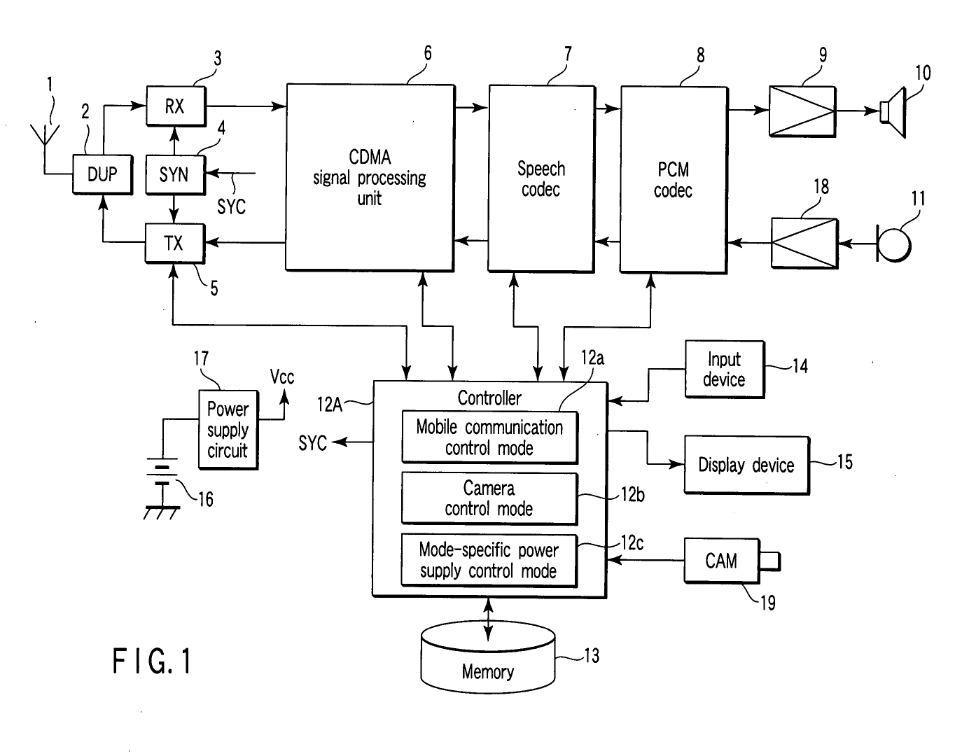

FIG. 1 is a block diagram showing the arrangement of a mobile communication terminal according to the present invention. This mobile communication terminal is a personal digital assistant (PDA) terminal having a radio interface using the code division multiple access (CDMA) scheme as a radio access scheme.

The radio signal transmitted from a base station (not shown) is received by an antenna 1 and then input to a reception circuit (RX) 3 through a duplexer (DUP) 2. In the reception circuit 3, the above radio signal is mixed with the reception local oscillation signal output from a frequency synthesizer (SYN) 4. With this operation, the radio signal is frequency-converted (downconverted) into an intermediate frequency signal or baseband signal. Note that the frequency of the reception local oscillation signal generated from the frequency synthesizer 4 is indicated by a control signal SYC output from a controller 12A.

The above reception intermediate frequency signal or reception baseband signal is input to a CDMA signal processing unit 6. The CDMA signal processing unit 6 performs quadrature demodulation processing for the input reception intermediate frequency signal or reception baseband signal and despreading processing using a spread code assigned to the reception channel, thereby obtaining demodulated data in a predetermined format. The demodulated data includes speech communication data, videophone communication data, and data for the transmission of e-mail or Web information. The speech communication data includes coded speech data and its control data. The videophone communication data includes coded speech data, coded video data, and their control data. The data for the transmission of e-mail and Web information includes text data and control data, and may include coded video data and speech data.

Of the demodulated data described above, the coded speech data is input to a speech coding/decoding unit (to be referred to as a speech codec hereinafter) 7. The speech codec 7 plays back baseband reception digital data by performing speech decoding processing and error correction decoding processing using Viterbi decoding for the input coded speech data. A PCM coding/decoding unit (to be referred to as a PCM codec hereinafter) 8 PCM-decodes the reception digital data output from the speech codec 7 and outputs an analog receive signal. This analog receive signal is amplified by a receive amplifier 9. The amplified signal is output from a loudspeaker 10.

Of the demodulated data described above, coded video data and text data are input to the controller 12A. The controller 12A decodes the above input coded video data and text data in accordance with the respective coding schemes. The decoded video data and text data are displayed on a display device 15, and stored in a memory 13 as needed.

A transmit signal from the user which is input through a microphone 11 at the time of speech communication is amplified to a proper level by a transmit amplifier 18. This signal is then converted into a digital speech signal by the PCM codec 8 and input to the speech codec 7. The speech codec 7 performs speech coding and error correction coding processing for the digital speech signal output from the PCM codec 8, and outputs the resultant signal to the CDMA signal processing unit 6.

At the time of videophone communication or data communication, the video signal output from a camera 19 is input to the CDMA signal processing unit 6 after being coded by the controller 12A. At the time of e-mail transmission, text data input as a mail text from an input device 14 and still image data taken by the camera 19 as an attached file are input to the CDMA signal processing unit 6 after being coded by the controller 12A.

The CDMA signal processing unit 6 performs spreading processing for the coded speech data output from the speech codec 7 and the coded video data and text data output from the controller 12A by using the spread code assigned to the transmission channel. After quadrature modulation processing is performed for the spread-coded transmission data, the quadrature modulated signal is output to a transmission circuit (TX) 5. The transmission circuit 5 frequency-converts (upconverts) the input quadrature modulated signal by mixing it with the transmission local oscillation signal generated from the frequency synthesizer 4. The transmission circuit 5 then high-frequency-amplifies the effective portion of the radio signal generated by the above frequency conversion, and outputs the resultant signal as a transmission radio signal. The transmission radio signal output from the transmission circuit 5 is supplied to the antenna 1 through the duplexer 2 and transmitted from the antenna 1 to a base station (not shown).

The input device 14 includes keys such as a dial keys, transmission key, power key, end key, volume control keys, and a mode designation key. The display device 15 includes an LCD and LEDs. The LCD displays the stored information of a telephone directory, an outgoing call/incoming call log, the telephone number of a terminal apparatus of the other party, the operation state of the self-apparatus, and the like.

A power supply circuit 17 includes a DC/DC converter, generates a predetermined operating power supply voltage Vcc on the basis of an output from a battery 16, and applies it to each circuit portion.

The controller 12A includes, for example, a microcomputer as a main controller. The controller 12A has a mobile communication control mode 12a, camera imaging/display control mode 12b, and mode-specific power supply control mode 12c as control modes associated with the present invention. Each of the control modes 12a to 12c is implemented by causing the microcomputer to execute a program.

When a data communication mode such as a telephone communication mode, videophone communication mode, or e-mail mode is designated through the input device 14, the mobile communication control mode 12a operates a circuit portion necessary for mobile communication based on the designated mode. In this state, the mobile communication control mode 12a executes control for the mobile communication.

When a videophone communication mode or camera mode is designated through the input device 14, the camera imaging/display control mode 12b operates a camera 19, and controls imaging operation by the camera 19 and display operation based on the image-sensed video data.

The mode-specific power supply control mode 12c divides the capacity of the battery 16 into the first and second capacities, and allocates the divided first and second capacities to the mobile communication mode and camera mode, respectively. The mobile communication modes include the telephone communication mode, videophone communication mode, and data communication mode. The camera modes include the mode of imaging/displaying using the camera 19 and storing data and the videophone communication mode. The mode-specific power supply control mode 12c calculates cumulative power consumption amounts in the above mobile communication mode and camera mode. When the calculated cumulative power consumption amounts exceed preset thresholds Th1 and Th2, the power consumptions in the mobile communication mode and camera mode are limited.

The mode-specific power supply control mode 12c includes a mode of setting/changing the relationship in the allocation between the first and second capacities with respect to the mobile communication mode and the camera mode or the ratio between the first and second capacities or their values in accordance with input operation by the user. The mode-specific power supply control mode 12c also includes a mode of calculating the remaining capacities of the first and second capacities on the basis of the calculated cumulative power consumption amounts, and displaying the calculated remaining capacities in correspondence with icons representing the mobile communication mode and camera mode.

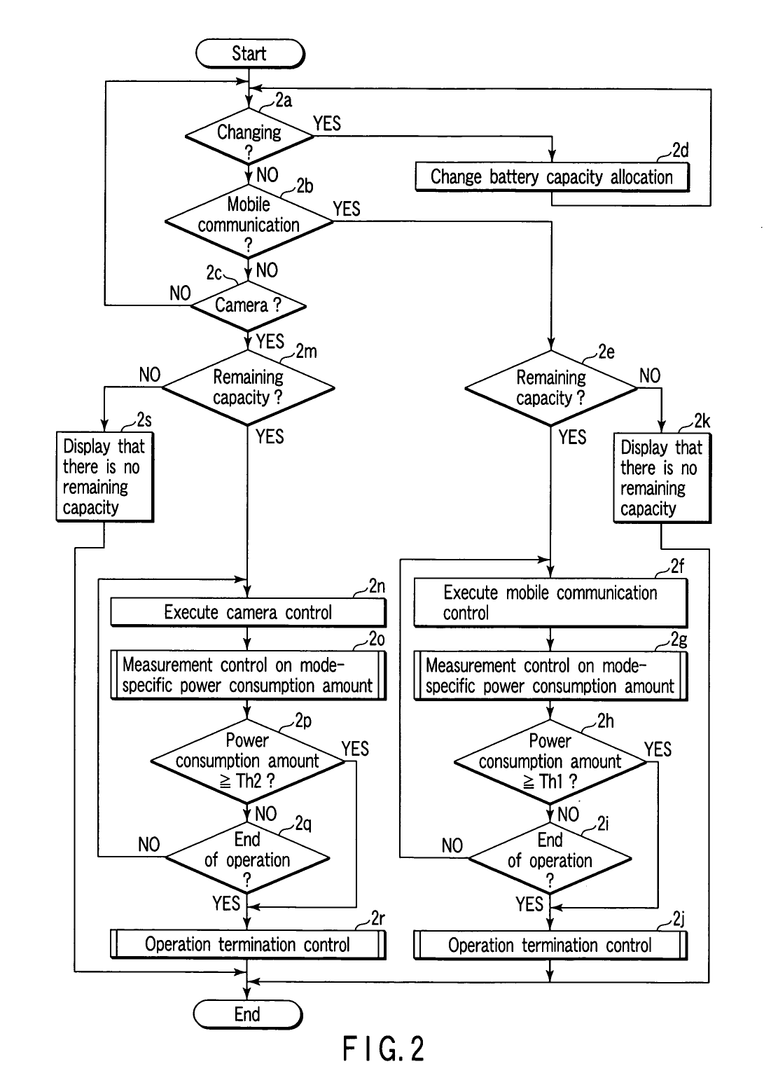

The operation of the mobile communication terminal having the above arrangement will be described in accordance with the control sequence by the controller 12A. FIGS. 2, 3, and 4 are flowcharts showing the control sequence by the controller 12A and its control contents.

In the standby state, the controller 12A monitors setting/changing operation for mode-specific power supply capacities, operation for mobile communication, and operation for imaging by the camera 19 in steps 2a, 2b, and 2c.

Assume that the user has performed setting/changing operation for mode-specific power supply capacities in this state. The controller 12A then shifts the flow to step 2d to receive the setting/changing information input by the user from the input device 14. The controller 12A then changes the default values of the first and second capacities stored in the memory in the controller 12A.

Assume that the user has placed higher importance on the mobile communication mode than on the camera mode, and input information for changing the allocation ratio between the first and second capacities for these modes to 70:30. In this case, the controller 12A changes the default values of the first and second capacities, e.g., 50:50 to 70:30. In contrast, assume that the user has placed higher importance on the camera mode than on the mobile communication mode, and input information for changing the ratio between the first and second capacities for these modes to 40:60. The controller 12A then changes the default values of the first and second capacities, i.e., 50:50 to 40:60. Note that the ratio between the first and second capacities may be fixed to 40:60, and the correspondence between first and second capacities and the mobile communication mode and camera mode may be changed.

Assume that after the above setting/changing operation for the mode-specific power supply capacities, the user has performed outgoing call operation for telephone communication. In this case, the controller 12A shifts the flow from step 2b to step 2e to check the remainder of the first capacity allocated to the mobile communication mode in the following manner. The remainder of the first capacity is stored in the memory in the controller 12A, and the controller 12A reads out the remainder of the first capacity corresponding to the mobile communication mode from the internal memory of the controller 12A. The controller 12A then compares the readout remainder of the first capacity with a threshold to check whether the remainder is equal to or less than the threshold.

If it is determined as a result of the comparison that the remainder is equal to or less than the threshold, since the first capacity allocated to the mobile communication mode has already been used up, the controller 12A determines that the mobile communication mode cannot be executed. In step 2k, the message “there is no remaining capacity” is displayed on the display device 15, together with an icon representing the mobile communication mode, and the flow returns to the standby state. The user can therefore clearly recognize that mobile communication cannot be done because the battery capacity allocated to mobile communication is insufficient.

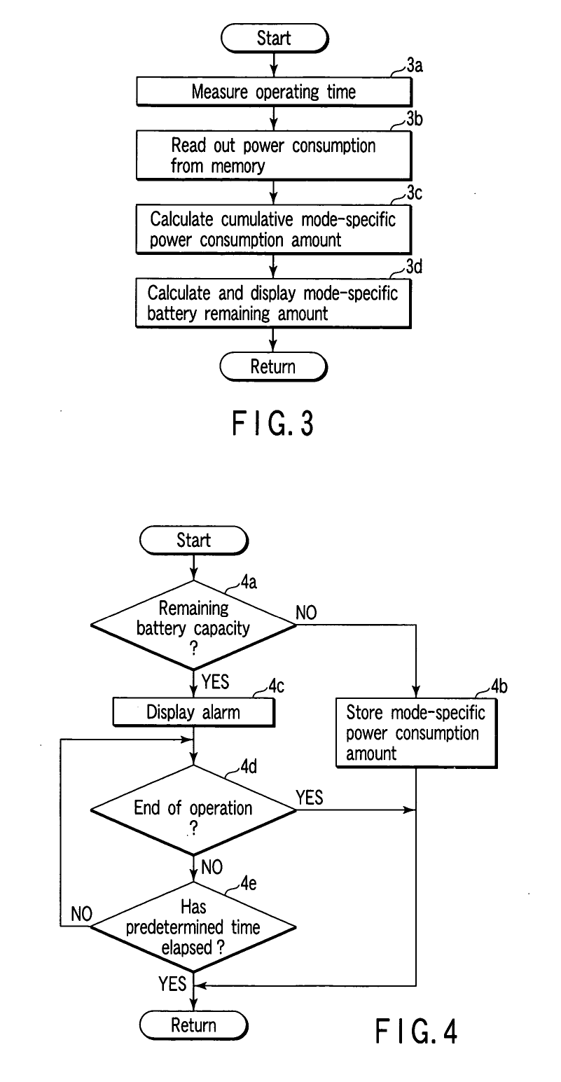

In contrast, assume that the remainder of the first capacity exceeds the threshold. In this case, the controller 12A determines that the first capacity allocated to the mobile communication mode is sufficient, and mobile communication operation can be performed, and executes mobile communication control in step 2f. During this mobile communication control, the controller 12A executes measurement control or mode-specific power consumption amounts in step 2g. FIG. 3 is a flowchart showing the corresponding control sequence and control contents.

First of all, in step 3a, the controller 12A measures an operation time in the mobile communication mode. In step 3b, the controller 12A reads out a rated power consumption value for the mobile communication mode from the internal memory. In step 3c, the controller 12A calculates a power consumption amount for the mobile communication mode from the readout rated power consumption value and the measured time of the above mobile communication operation. The controller 12A then calculates the latest cumulative power consumption amount in the mobile communication mode by adding the calculated current power consumption amount in the mobile communication mode to the previous cumulative power consumption amount in the mobile communication mode which is stored in the internal memory.

Subsequently, in step 3d, the controller 12A calculates the remainder of the first capacity allocated to the mobile communication mode on the basis of the latest cumulative power consumption amount calculated in the above manner, and displays the calculated remainder of the first capacity on the display device 15 in correspondence with the icon representing the mobile communication mode. The user can therefore recognize the remainder of the battery capacity allocated to the mobile communication mode during the mobile communication mode.

In addition, during the mobile communication mode, the controller 12A compares the latest cumulative power consumption amount calculated in step 2h with the threshold Th1. The threshold Th1 is set in accordance with the allocation ratio between mode-specific power supply capacities set in advance, which is 70:30. If the cumulative power consumption amount is less than the threshold Th1, the flow returns to step 2f to repeatedly execute mobile communication control and measurement control on mode-specific power consumption amounts.

In contrast, assume that communication termination operation is performed through the input device 14 during the above mobile communication operation, or the cumulative power consumption amount is equal to or more than the threshold Th1. In this case, the controller 12A shifts to step 2j to execute processing for terminating the mobile communication mode in the following manner. FIG. 4 is a flowchart showing the corresponding sequence and contents.

First of all, the controller 12A checks in step 4a whether or not the battery capacity (first capacity) for the mobile communication mode is left. If it is determined that no remainder is left, the controller 12A generates, in step 4c, an alarm indicating that the first capacity has run out. In step 4e, the controller 12A monitors the time elapsed since the above cumulative power consumption amount became equal to more than the threshold Th1 in step 4e. In step 4d, the controller 12A monitors operation for terminating the mobile communication mode. Assume that a predetermined time has elapsed without detecting or performing communication termination operation. In this case, the controller 12A forcibly stops the operation in the mobile communication mode and returns to the standby state.

In contrast, assume that the battery capacity (first capacity) for the mobile communication mode remains sufficiently high. In this case, to make preparation for the subsequent execution of the mobile communication mode, the latest cumulative power consumption amount calculated in step 3c and the remainder of the first capacity calculated on the basis of the cumulative power consumption amount in step 3d are stored in the memory in the controller 12A in step 4b. The stored cumulative power consumption amount is used for the measurement of a mode-specific power consumption amount in the next operation in the mobile communication mode (step 2g). The remainder is used to check the battery remainder before the start of the next operation in the mobile communication mode (step 2e).

Assume that the user has started the camera 19 in the standby state. In this case, the controller 12A shifts from step 2c to step 2m to check the remainder of the second capacity allocated to the camera mode as in the above case of telephone communication. If it is determined that the remainder is equal to or less than the threshold, it is determined that the second capacity allocated to the camera mode has already been used up, and imaging operation by the camera 19 cannot be done. In step 2s, the message “there is no remaining capacity” is displayed on the display device 15, together with an icon representing the camera mode, and the flow returns to the standby state.

In contrast, assume that the remainder of the second capacity exceeds the threshold. In this case, the controller 12A determines that the second capacity allocated to the camera mode remains sufficiently high, and imaging operation by the camera 19 can be done. In step 2n, the controller 12A executes the imaging/display control mode of the camera 19. With this operation, an object image is sensed by the camera 19, and the imaging data is supplied from the controller 12A to the display device 15 to be displayed. When the shutter button provided on the input device 14 is pressed or recording operation is performed in this state, the above imaging data is stored in the memory 13 by the controller 12A.

During imaging/display control on the camera 19, the controller 12A executes measurement control on a mode-specific power consumption amount in step 2o. In this camera mode, measurement control on a mode-specific power consumption amount is performed in accordance with the control sequence and control contents shown in FIG. 3 as in the above case of the mobile communication mode.

That is, first of all, the imaging time of the camera 19 is measured in step 3a. In step 3b, the controller 12A reads out a rated power consumption value for the camera mode from the internal memory. In step 3c, the controller 12A calculates a power consumption amount for the current imaging operation by the camera 19 from the readout rated power consumption value and the measured imaging time of the camera 19. The controller 12A then calculates the latest cumulative power consumption amount in the imaging operation by the camera 19 by adding the calculated current power consumption amount in the imaging operation of the camera 19 to the previous cumulative power consumption amount in the imaging operation of the camera 19 which is stored in the internal memory.

Subsequently, in step 3d, the controller 12A calculates the remainder of the second capacity allocated to the camera mode on the basis of the latest cumulative power consumption amount calculated in the above manner, and displays the calculated remainder of the second capacity on the display device 15 in correspondence with the icon representing the camera mode. The user can therefore recognize the remainder of the battery capacity allocated to the camera mode during the imaging operation of the camera 19.

In addition, during the imaging operation of the camera 19, the controller 12A compares the latest cumulative power consumption amount calculated in step 2p with the threshold Th2. The threshold Th2 is set in accordance with the allocation ratio between mode-specific power supply capacities set in advance, which is 70:30. If the cumulative power consumption amount is less than the threshold Th2, the flow returns to step 2n to repeatedly execute imaging/display control on the camera 19 and measurement control on mode-specific power consumption amounts.

In contrast, assume that imaging termination operation is performed through the input device 14 during the imaging operation of the camera 19, or the cumulative power consumption amount is equal to or more than the threshold Th2. In this case, the controller 12A shifts to step 2r to execute processing for terminating the imaging operation of the camera 19 in accordance with the sequence shown in FIG. 4 as in the above case of the mobile communication mode.

First of all, the controller 12A checks in step 4a whether or not the battery capacity (second capacity) for the camera mode is left. If it is determined that no remainder is left, the controller 12A generates, in step 4c, an alarm indicating that the second capacity has run out. In step 4e, the controller 12A monitors the time elapsed since the above cumulative power consumption amount became equal to more than the threshold Th2 in step 4e. In step 4d, the controller 12A monitors imaging termination operation for the camera 19. Assume that a predetermined time has elapsed without detecting or performing imaging termination operation. In this case, the controller 12A forcibly stops the imaging operation of the camera 19 and returns to the standby state.

In contrast, assume that the battery capacity (second capacity) for the camera mode remains sufficiently high. In this case, to make preparation for the subsequent imaging operation of the camera 19, the latest cumulative power consumption amount calculated in step 3c and the remainder of the second capacity calculated on the basis of the cumulative power consumption amount in step 3d are stored in the memory in the controller 12A in step 4b. The stored cumulative power consumption amount is used for the measurement of a mode-specific power consumption amount in the next imaging operation of the camera 19 (step 2o). The remainder of the second capacity is used to check the battery remainder before the start of the next imaging operation of the camera 19 (step 2m).

In performing videophone communication or transmitting image data upon attaching it to e-mail while imaging an object with the camera 19, the terminal cannot be used when either the cumulative power consumption amount in the mobile communication mode becomes equal to or more than the threshold Th1 or the cumulative power consumption amount in the camera mode becomes equal to or more than the threshold Th2.

As described above, according to the first embodiment, the capacity held by the battery 16 is divided into the first and second capacities, and the divided first and second capacities are allocated to the mobile communication mode and camera mode, thereby allowing the use of the mobile communication mode and camera mode within the ranges of the allocated first and second capacities.

If, therefore, for example, the allocation ratio between the first and second capacities is set to 70:30, 70% of the total capacity held by the battery 16 can be used for the mobile communication mode, and 30% of the total capacity can be used for the camera mode. This can reliably prevent the user from being disabled to perform mobile communication because of a battery capacity shortage in performing outgoing call operation when the battery 16 drains as the camera mode is used, or can reliable prevent the user from being disabled to use the camera mode when required as the battery 16 drains upon frequent telephone communication.

Since the allocation ratio between the first and second capacities can be set/changed in accordance with input operation by the user, the allocation ratio between battery capacities can be arbitrarily set in accordance with the form of use desired by each user. If, for example, the frequency of use or the degree of importance of the mobile communication mode is higher than that of the camera mode, the ratio of the first capacity to the total capacity is set to be higher than that of the second capacity. In contrast to this, if the frequency of use or the degree of importance on the camera mode is higher than that of the mobile communication mode, the ratio of the second capacity to the total capacity is set to be higher than that of the first ratio.

In addition, during mobile communication operation or imaging operation of the camera 19, remaining battery capacities which can be used in the respective modes are calculated and displayed in correspondence with icons representing the modes. The user can therefore check the remaining battery capacities in the respective modes during operation in the mobile communication mode and imaging operation of the camera 19.

When the cumulative power consumption amounts become equal to or more than the thresholds Th1 and Th2 during operation in the mobile communication mode and imaging operation of the camera 19, an alarm is displayed, and mobile communication operation and imaging operation of the camera 19 are not immediately stopped, but are stopped after a lapse of a predetermined time since an alarm is displayed. For this reason, during telephone communication or imaging operation of the camera 19, the operation is not abruptly and forcibly terminated, thereby reducing the sense of discomfort of the user.

### Second Embodiment

According to the second embodiment of the present invention, when a battery is comprised of a plurality of cells, the battery is divided into the first and second cells. When the mobile communication mode is to be used, the first cell is selected. When the camera mode is to be used, the second cell is selected.

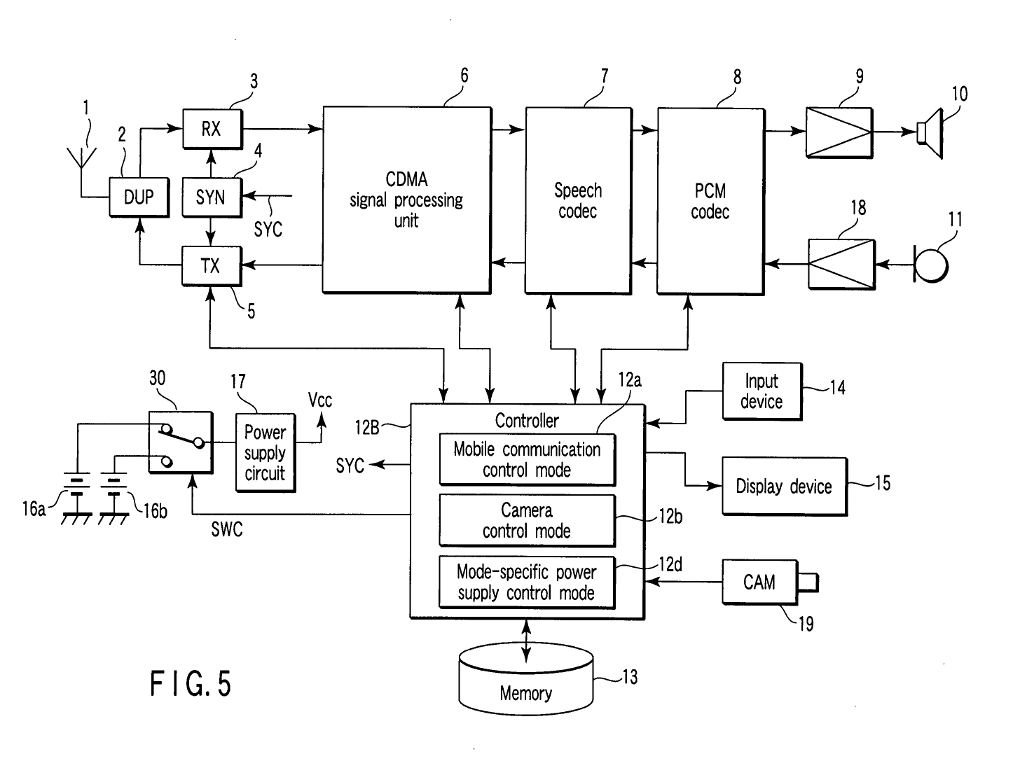

FIG. 5 is a circuit block diagram showing the arrangement of a mobile communication terminal according to the second embodiment of the present invention. The same reference numerals as in FIG. 1 denote the same parts in FIG. 5, and a detailed description thereof will be omitted.

The battery is comprised of a first cell 16a and second cell 16b. A switch 30 is provided between the first and second cells 16a and 16b and a power supply circuit 17. The switch 30 is formed from a semiconductor switch and switched by a switching control signal SWC output from a controller 12B.

The controller 12B includes a mobile communication control mode 12a, camera imaging/display control mode 12b, and mode-specific power supply control mode 12d as control modes associated with the present invention. Each of the control modes 12a, 12b, and 12d is implemented by causing a microcomputer to execute a program.

When start operation for mobile communication is performed through the input device 14, the mode-specific power supply control mode 12d switches the switch 30 to the first cell 16a side by outputting the switching control signal SWC. When start operation for a camera 19 is performed, the mode-specific power supply control mode 12d switches the switch 30 to the second cell 16b side by outputting the switching control signal SWC. In addition, the mode-specific power supply control mode 12d detects the remaining capacities of the first and second cells 16a and 16b, and displays the detected values in correspondence with icons representing the mobile communication mode and camera mode. The mode-specific power supply control mode 12d also includes a function of stopping operation in the mobile communication mode and camera imaging operation when the remaining capacities become lower than lower limits. The mode-specific power supply control mode 12d further includes a function of setting/changing the correspondence between the above mobile communication mode and camera mode and the first and second cells 16a and 16b in accordance with input operation by a user.

With this arrangement, if the user performs, for example, outgoing call operation for telephone communication, the controller 12B checks, on the basis of a mode-specific power supply control flag stored in the internal memory, whether a battery capacity high enough to perform mobile communication is left in the first cell 16a. If the remaining capacity of the first cell 16a is sufficient, the controller 12B shifts to operation in the mobile communication mode. If the battery capacity is insufficient, a corresponding message is displayed on a display device 15, and the terminal returns to the standby state. That is, if the battery capacity of the first cell 16a is insufficient, operation in the mobile communication mode is rejected.

Upon shifting to operation in the mobile communication mode, the controller 12B outputs the switching control signal SWC to switch the switch 30 to the first cell 16a side. As a consequence, the power supply circuit 17 generates an operating power supply voltage Vcc for mobile communication operation on the basis of the power supply output of the first cell 16a. The generated operating power supply voltage Vcc is applied to circuits necessary for operation in the mobile communication mode.

The controller 12B also detects the remaining capacity of the first cell 16a and displays the detection result on the LCD device 15. At the same time, the controller 12B monitors whether the remaining capacity of the first cell 16a becomes lower than the lower limit. If the capacity becomes lower than the lower limit, the controller 12B notifies the user of a message indicating the remaining capacity of the first cell 16a has run out, and then forcibly terminates the operation in the mobile communication mode. Note that when the remaining capacity of the first cell 16a becomes lower than the lower limit, the corresponding message is stored in the internal memory of the controller 12B as a mode-specific power supply control flag for rejecting the next operation in the mobile communication mode.

Assume that the user performs start operation for the camera 19 through an input device 14. In this case, the controller 12B checks, on the basis of the mode-specific power supply control flag stored in the internal memory, whether a battery capacity high enough to perform imaging/display operation of the camera 19 is left in the second cell 16b. If the remaining capacity of the second cell 16b is sufficient, the controller 12B shifts to operation in the camera imaging/display mode. If the capacity of the second cell 16b is insufficient, a corresponding message is displayed on the display device 15, and the terminal returns to the standby state. That is, if the battery capacity of the second cell 16b is insufficient, operation in the imaging/display mode of the camera 19 is rejected in advance.

Upon shifting to operation in the imaging/display mode of the camera 19, the controller 12B outputs the switching control signal SWC to switch the switch 30 to the second cell 16b side. As a consequence, the power supply circuit 17 generates the operating power supply voltage Vcc for camera imaging operation on the basis of the power supply output of the second cell 16b, and applies the generated operating power supply voltage Vcc to circuits necessary for the imaging/display operation of the camera 19. Subsequently, imaging operation for moving or still images of an object by the camera 19 and display operation for sensed images are performed.

The controller 12B also detects the remaining capacity of the second cell 16b and displays the detection result on the LCD device 15. In addition, the controller 12B monitors whether or not the remaining capacity of the second cell 16b becomes lower than the lower limit. If the remaining capacity becomes lower than the lower limit, the controller 12B generates a message indicating that the remaining capacity of the second cell 16b has run out, notifies the user of the message, and forcibly terminates the imaging operation of the camera. Note that if the remaining capacity of the second cell 16b becomes lower than the lower limit, the corresponding message is stored in the internal memory of the controller 12B as a mode-specific power supply control flag for rejecting the next camera imaging operation.

Note that videophone communication or transmission of sensed image data upon attaching it to e-mail while imaging an object with the camera 19 is executed only when both the first and second cells 16a and 16b have sufficient capacities.

As described above, according to the second embodiment, a battery constituted by a plurality of cells is divided into the first cell 16a and second cell 16b. When operation for executing the mobile communication mode is performed, the remaining capacity of the first cell 16a is checked, and the switch 30 is then switched to the first cell 16a side to apply an operating voltage to corresponding circuits for mobile communication operation. In contrast, when start operation for the camera 19 is performed, the remaining capacity of the second cell 16b is checked, and the switch 30 is then switched to the second cell 16b side to apply operating power for the imaging operation of the camera 19 to corresponding circuits.

The mobile communication mode and camera mode are therefore operated by the power supply voltages generated on the basis of the outputs of the first and second cells 16a and 16b which are independent and different from each other. Like the first embodiment, therefore, this embodiment can reliably prevent the user from being disabled to perform communication in the mobile communication because of a battery capacity shortage in performing outgoing call operation when the battery drains as the camera mode is used, or can reliably prevent the user from being disabled to use the camera mode when required as the battery 16 drains upon frequent telephone communication. In addition, the power supply systems for the mobile communication mode and camera mode are spatially separated from each other, and the remaining capacities of these power supply systems can be detected by detecting the output voltages of the first and second cells using an existing detection system. For this reason, the controller 12B need not perform the processing of calculating the cumulative battery consumption amount in each mode, thereby simplifying the power supply control processing in the controller 12B.

In addition, the remaining capacities of the first and second cells 16a and 16b are detected, and the detected values are displayed in correspondence with the icons representing the mobile communication mode and camera mode. This allows the user to check the remaining battery capacities for the respective modes during operation in the mobile communication mode and imaging operation of the camera 19.

The mode-specific power supply control mode 12d also includes a function of setting/changing the correspondence between the above mobile communication mode and camera mode and the first and second cells 16a and 16b in accordance with input operation by the user. The user can therefore change the correspondence between the respective modes and the cells 16a and 16b, as needed. As a consequence, even if the battery capacity of the first cell 16a which was initially set for the mobile communication mode has run out, communication in the mobile communication mode can be continued by performing setting/changing of operation so as to correlate the second cell 16b with the mobile communication mode, as needed. In contrast to this, even if the battery capacity of the second cell 16b which was initially set for the camera mode becomes insufficient, the user can continue imaging by the camera 19 by performing setting/changing operation so as to correlate the first cell 16a with the camera mode, as needed.

### Third Embodiment

According to the third embodiment of the present invention, in a mobile communication terminal having a television broadcast reception mode as an optional mode, the capacity held by a battery is divided into the first and second capacities. The divided first and second capacities are allocated to the mobile communication mode and the above television broadcast reception mode, respectively. This makes it possible to use the mobile communication mode and television broadcast reception mode within the ranges of the first and second capacities allocated to the respective modes in the above manner.

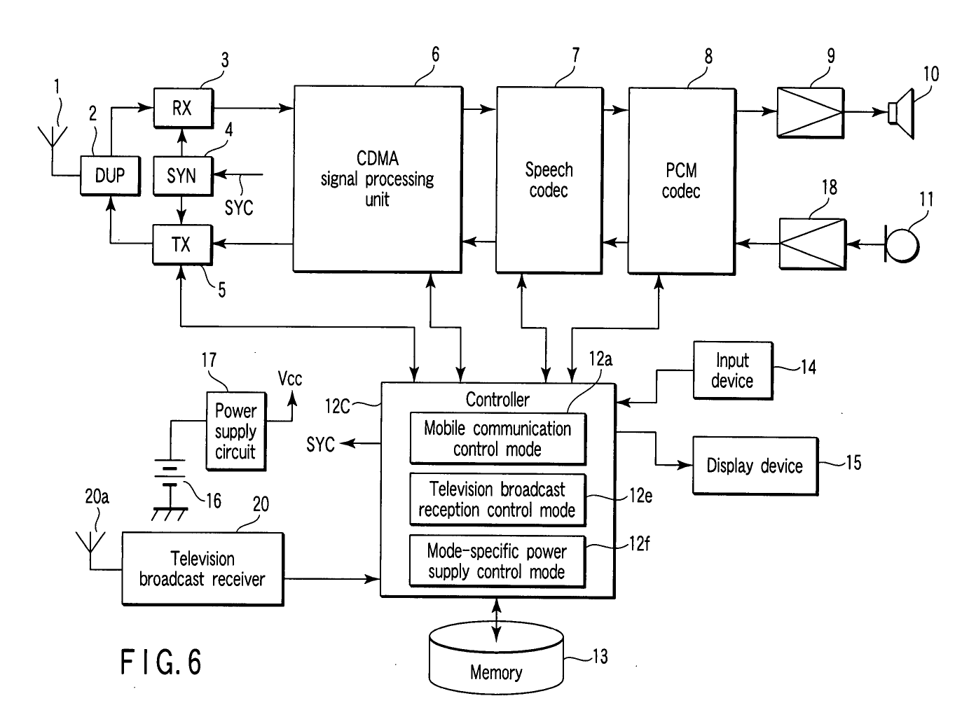

FIG. 6 is a block diagram showing the arrangement of a mobile communication terminal according to the third embodiment of the present invention. The same reference numerals as in FIG. 1 denote the same parts in FIG. 6, and a detailed description thereof will be omitted. The mobile communication terminal according to the third embodiment includes a television broadcast receiver 20. The television broadcast receiver 20 has a function of receiving a broadcast signal such as an analog terrestrial broadcast signal, digital terrestrial broadcast signal, or digital satellite broadcast signal, and demodulating it.

A controller 12C includes a microcomputer as a main controller. The controller 12C includes a mobile communication control mode 12a, television broadcast reception control mode 12e, and mode-specific power supply control mode 12f as control modes associated with the present invention. Each of the control modes 12a, 12e, and 12f is implemented by causing the microcomputer to execute a program.

Of these control modes, the television broadcast reception control mode 12e operates the television broadcast receiver 20 when the television broadcast reception mode is designated through an input device 14. The television broadcast reception control mode 12e displays the video signal contained in a received/demodulated broadcast signal on a display device 15, and also outputs an audio signal from a loudspeaker 10.

The mode-specific power supply control mode 12f divides the capacity of a battery 16 into the first and second capacities, and allocates the divided first and second capacities to the mobile communication mode and television broadcast reception mode, respectively. The mode-specific power supply control mode 12f then calculates the cumulative power consumption amounts in the mobile communication mode and television broadcast reception mode. When the calculated cumulative power consumption amounts exceed preset thresholds Th1 and Th2, the mode-specific power supply control mode 12f limits subsequent power consumptions in the mobile communication mode and television broadcast reception mode.

The mode-specific power supply control mode 12f sets/changes the relationship in allocation between the mobile communication mode and television broadcast reception mode and the first and second capacities, the ratio between the first and second capacities, or their values in accordance with input operation by the user. The mode-specific power supply control mode 12f has a function of calculating the remaining capacities of the first and second capacities on the basis of the calculated cumulative power consumption amounts, and displaying the calculated remaining capacities in correspondence with icons representing the mobile communication mode and television broadcast reception mode.

With this arrangement, as in the first embodiment, the capacity held by the battery 16 is distributed to the mobile communication mode and television broadcast reception mode in accordance with a set allocation ratio. Mobile communication operation and television broadcast reception operation can be done within the ranges of the distributed capacities. This embodiment can prevent the user from being prevented from performing mobile communication because of a battery capacity shortage in performing outgoing call operation when the battery drains as the television broadcast reception mode is used, or can prevent the user from being prevented from watching a television broadcast when required as the battery 16 drains upon frequent telephone communication.

The allocation ratio between the first and second capacities is set/changed in accordance with input operation by the user. The allocation ratio between battery capacities can be arbitrarily set in accordance with the usage form desired by each user. If, for example, the frequency of use or the degree of importance of the mobile communication mode is higher than of the television broadcast reception mode, the ratio of the first capacity to the total capacity is set to be higher than that of the second capacity. In contrast to this, if the frequency of use or the degree of importance on the television broadcast reception mode is higher than that of the mobile communication mode, the ratio of the second capacity to the total capacity is set to be higher than that of the first ratio.

In addition, during mobile communication operation or operation of the television broadcast receiver 20, remaining battery capacities which can be used in the respective modes are calculated and displayed on the display device 15 in correspondence with icons representing the modes. The user can therefore check the remaining battery capacities in the respective modes during operation in the mobile communication mode and watching a television broadcast.

In the third embodiment, as in the first embodiment, when the cumulative power consumption amounts become equal to or more than the thresholds Th1 and Th2 during operation in the mobile communication mode and seeing a television broadcast, an alarm is displayed, and the operation in the mobile communication mode and the operation of the television broadcast receiver 20 are not immediately stopped, but are stopped after a lapse of a predetermined time since an alarm is displayed. For this reason, during telephone communication or watching a television broadcast, the operation is not abruptly and forcibly terminated, thereby reducing the sense of discomfort of the user.

### Fourth Embodiment

According to the fourth embodiment of the present invention, in a mobile communication terminal having a content playback mode as an additional function, the capacity held by a battery is divided into the first and second capacities. The divided first and second capacities are respectively allocated to the mobile communication mode and content playback mode. This makes it possible to use the mobile communication mode and content playback mode within the ranges of the allocated first and second capacities.

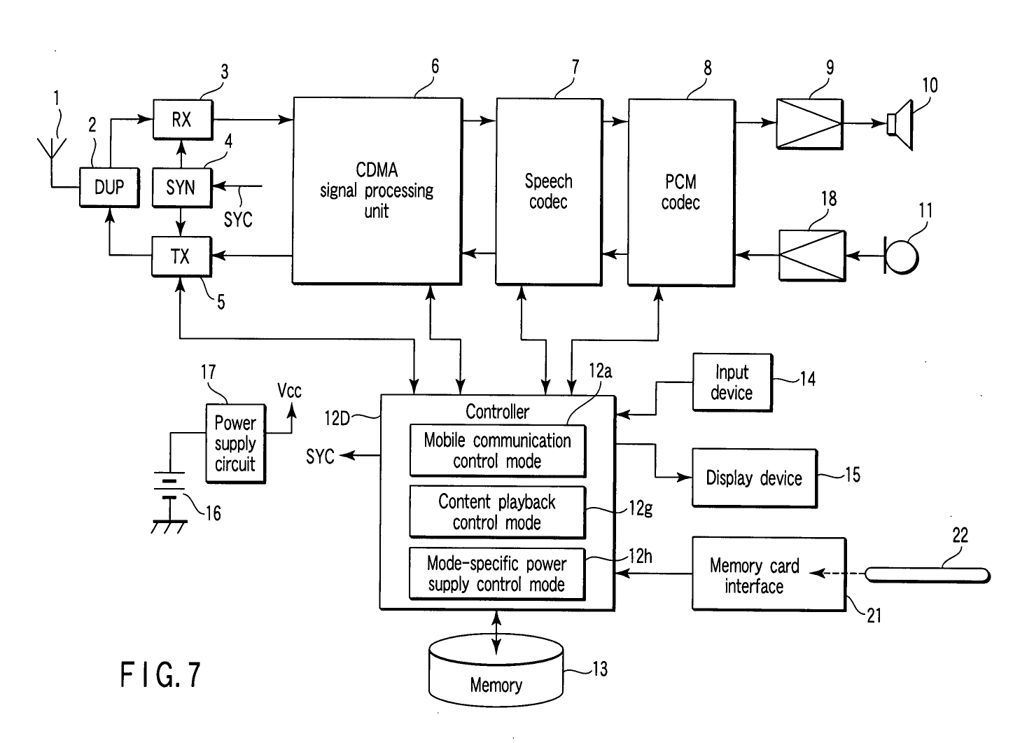

FIG. 7 is a block diagram showing the arrangement of a mobile communication terminal according to the fourth embodiment of the present invention. The same reference numerals as in FIG. 1 denote the same parts in FIG. 1, and a detailed description thereof will be omitted. A mobile communication terminal according to the fourth embodiment includes a memory card interface 21. When a memory card 22 is inserted in the terminal, the memory card interface 21 loads content data from the memory card under the control of a controller 12D. As the memory card 22, a compact memory card using a flash memory such as a compact flash (registered trademark), Secure Digital (SD) memory card (registered trademark), or memory stick (registered trademark) is used.

The controller 12D includes a microcomputer as a main controller. The controller 12D includes a mobile communication control mode 12a, content playback control mode 12g, and mode-specific power supply control mode 12h as control modes associated with the present invention. Each of the control modes 12a, 12b, and 12h is implemented by causing the microcomputer to execute a program.

Of these control modes, the content playback control mode 12g loads content data from the memory card 22 through the memory card interface 21 when the content playback mode is designated through an input device 14. The content playback control mode 12g then plays back the loaded content data. The playback forms to be used include both the form of decoding video contents and displaying them on a display device 15 and the form of decoding audio contents such as musical pieces and outputting them from a loudspeaker 10.

The mode-specific power supply control mode 12h divides the capacity of a battery 16 into the first and second capacities, and allocates the divided first and second capacities to the mobile communication mode and content playback mode, respectively. The mode-specific power supply control mode 12h then calculates the cumulative power consumption amounts in the mobile communication mode and content playback mode. When the calculated cumulative power consumption amounts exceed preset thresholds Th1 and Th2, the mode-specific power supply control mode 12h limits subsequent power consumptions in the mobile communication mode and content playback mode.

The mode-specific power supply control mode 12h sets/changes the relationship in allocation between the mobile communication mode and content playback mode and the first and second capacities, the ratio between the first and second capacities, or their values in accordance with input operation by the user. The mode-specific power supply control mode 12h has a function of calculating the remaining capacities of the first and second capacities on the basis of the calculated cumulative power consumption amounts, and displaying the calculated remaining capacities in correspondence with icons representing the mobile communication mode and content playback mode.

With this arrangement, as in the first and third embodiments, the capacity held by the battery 16 is distributed to the mobile communication mode and content playback mode in accordance with a set allocation ratio. Mobile communication operation and content playback operation can be done within the ranges of the distributed capacities. This embodiment can prevent the user from being prevented from performing mobile communication because of a battery capacity shortage in performing outgoing call operation when the battery drains as the content playback mode is used, or can prevent the user from being prevented from playing back contents when required as the battery 16 drains upon frequent telephone communication.

The allocation ratio between the first and second capacities is set/changed in accordance with input operation by the user. The allocation ratio between battery capacities can be arbitrarily set in accordance with the form of use desired by each user. If, for example, the frequency of use or the degree of importance of the mobile communication mode is higher than of the content playback mode, the ratio of the first capacity to the total capacity is set to be higher than that of the second capacity. In contrast to this, if the frequency of use or the degree of importance on the content playback mode is higher than that of the mobile communication mode, the ratio of the second capacity to the total capacity is set to be higher than that of the first ratio.

In addition, during mobile communication operation or playback of contents, remaining battery capacities which can be used in the respective modes are calculated and displayed on the display device 15 in correspondence with icons representing the modes. The user can therefore check the remaining battery capacities in the respective modes during operation in the mobile communication mode and playback of contents.

In this embodiment, as in the first and third embodiments, when the cumulative power consumption amounts become equal to or more than the thresholds Th1 and Th2 during operation in the mobile communication mode and playback of contents, an alarm is displayed, and the operation in the mobile communication mode and playback of contents are not immediately stopped, but are stopped after a lapse of a predetermined time since an alarm is displayed. For this reason, during telephone communication or playback of contents, the operation is not abruptly and forcibly terminated, thereby reducing the sense of discomfort of the user.

### Fifth Embodiment

According to the fifth embodiment of the present invention, in a mobile communication terminal including a camera mode and television broadcast reception mode as additional functions, the capacity held by a battery is divided into the first and second capacities, and the second capacity is divided into the third and fourth capacities. The first capacity is allocated to the mobile communication mode, and the third and fourth capacities are allocated to the camera mode and television broadcast reception mode, respectively. This makes it possible to use the mobile communication mode, camera mode, and television broadcast reception mode within the ranges of the allocated first, second, and third capacities.

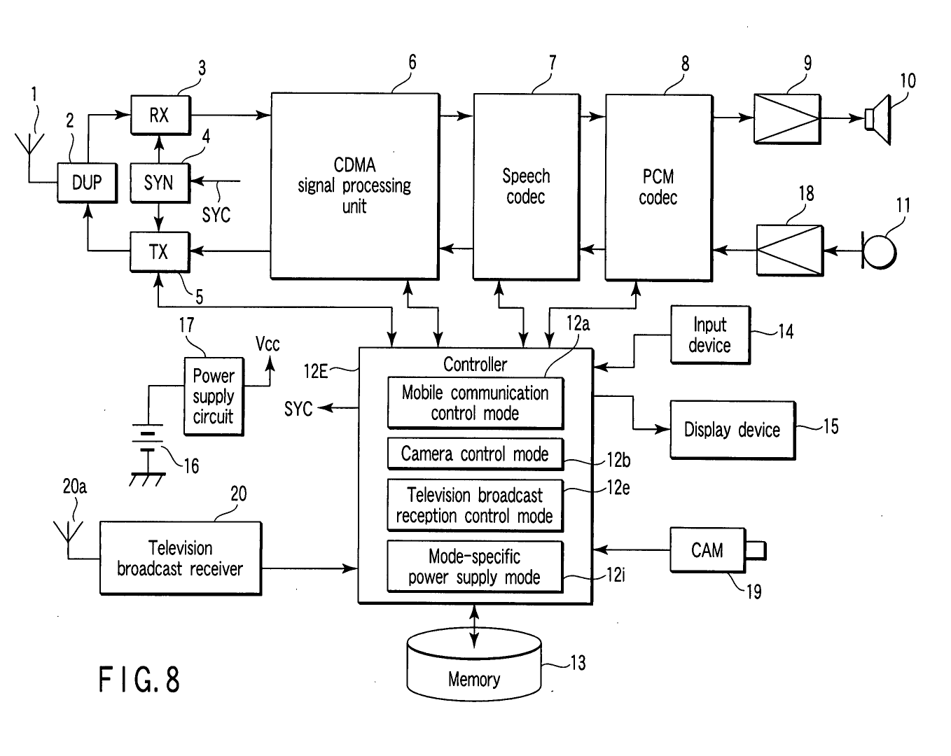

FIG. 8 is a block diagram showing the arrangement of a mobile communication terminal according to the fifth embodiment of the present invention. The same reference numerals as in FIGS. 5 and 1 denote the same parts in FIG. 8, and a detailed description thereof will be omitted. The mobile communication terminal according to the fifth embodiment includes a camera 19 and television broadcast receiver 20.

The controller 12E includes a microcomputer as a main controller. The controller 12E includes a mobile communication control mode 12a, camera imaging/display control mode 12b, television broadcast reception control mode 12e, and mode-specific power supply mode 12i as control modes according to the present invention. Each of the control modes 12a, 12b, 12e, and 12i is implemented by causing the microcomputer to execute a program.

Of these modes, the mode-specific power supply mode 12i divides the capacity of a battery 16 into the first and second capacities, and further divides the second capacity into the third and fourth capacities. The first, third, and fourth capacities are then allocated to the mobile communication mode, camera mode, and television broadcast reception mode, respectively. The mobile communication mode includes a telephone communication mode, videophone communication mode, and data communication mode. The camera mode includes a mode of imaging/displaying using the camera 19 and storing data and the videophone communication mode. Cumulative power consumption amounts in the mobile communication mode, camera mode, and television broadcast reception mode are calculated. When the calculated cumulative power consumption amounts exceed preset thresholds Th1, Th3, and Th4, the mode-specific power supply mode 12i limits the subsequent power consumptions in the mobile communication mode, camera mode, and television broadcast reception mode.

The mode-specific power supply mode 12i also includes a mode of setting/changing the correspondence between the mobile communication mode, camera mode, and television broadcast reception mode and the first, third, and fourth capacities, the ratios between the first, third, and fourth capacities, or their values in accordance with input operation by the user. The mode-specific power supply mode 12i further includes a mode of calculating the remaining capacities of the first, third, and fourth capacities on the basis of the calculated cumulative power consumption amounts, and displaying the calculated remaining capacities in correspondence with icons representing the mobile communication mode, camera mode, and television broadcast reception mode.

With this arrangement, the capacity held by the battery 16 is distributed to the mobile communication mode, camera mode, and television broadcast reception mode in accordance with set allocation ratios. Operation in the mobile communication mode, imaging/display operation by the camera 19, and reception of a television broadcast are performed within the ranges of the distributed capacities. This embodiment can therefore prevent the user from being prevented from performing mobile communication because of a battery capacity shortage in performing outgoing call operation when the battery 16 drains as the camera mode or television broadcast reception mode is used, or can prevent the user from being prevented from using the camera 19 or see a television broadcast when required as the battery 16 drains upon frequent telephone communication.

The allocation ratios between the first, third, and fourth capacities are set/changed in accordance with input operation by the user. The allocation ratios of battery capacities can be arbitrarily set in accordance with the form of use desired by each user. If, for example, the frequency of use or the degree of importance of the mobile communication mode is higher than of the camera mode or television broadcast reception mode, the ratio of the first capacity to the total capacity is set to be higher than that of the third or fourth capacity. In contrast to this, if the frequency of use or the degree of importance on the camera mode or television broadcast reception mode is higher than that of the mobile communication mode, the ratio of the third or fourth capacity to the total capacity is set to be higher than that of the first ratio.

In addition, during operation in the mobile communication mode, imaging and display operation by the camera 19, or the operation of the television broadcast receiver 20, remaining battery capacities which can be used in the respective modes are calculated and displayed on a display device 15 in correspondence with icons representing the modes. The user can therefore check the remaining battery capacities in the respective modes during operation in the mobile communication mode, imaging by the camera 19, and seeing a television broadcast.

In this embodiment, as in the first and third embodiments, when the cumulative power consumption amount becomes equal to or more than the threshold Th1, Th2, or Th3 during operation in the mobile communication mode, imaging by the camera 19, or seeing a television broadcast, an alarm is displayed, and mobile communication operation, imaging/display operation by the camera 19, or the operation of the television broadcast receiver 20 is not immediately stopped, but is stopped after a lapse of a predetermined time since the alarm is displayed. For this reason, during telephone communication, imaging by the camera 19, or watching a television broadcast, the operation is not abruptly and forcibly terminated, thereby reducing the sense of discomfort of the user.

### Sixth Embodiment

According to the sixth embodiment of the present invention, in a mobile telephone terminal having a mobile communication mode including a mode of waiting for an incoming call and a radio communication mode for speech communication and data communication, the first capacity is allocated to the incoming call waiting mode and radio communication mode. The second capacity is allocated to the camera mode. This makes it possible to use the incoming call waiting mode and radio communication mode within the range of the allocated first capacity and to use the camera mode within the range of the allocated second capacity.

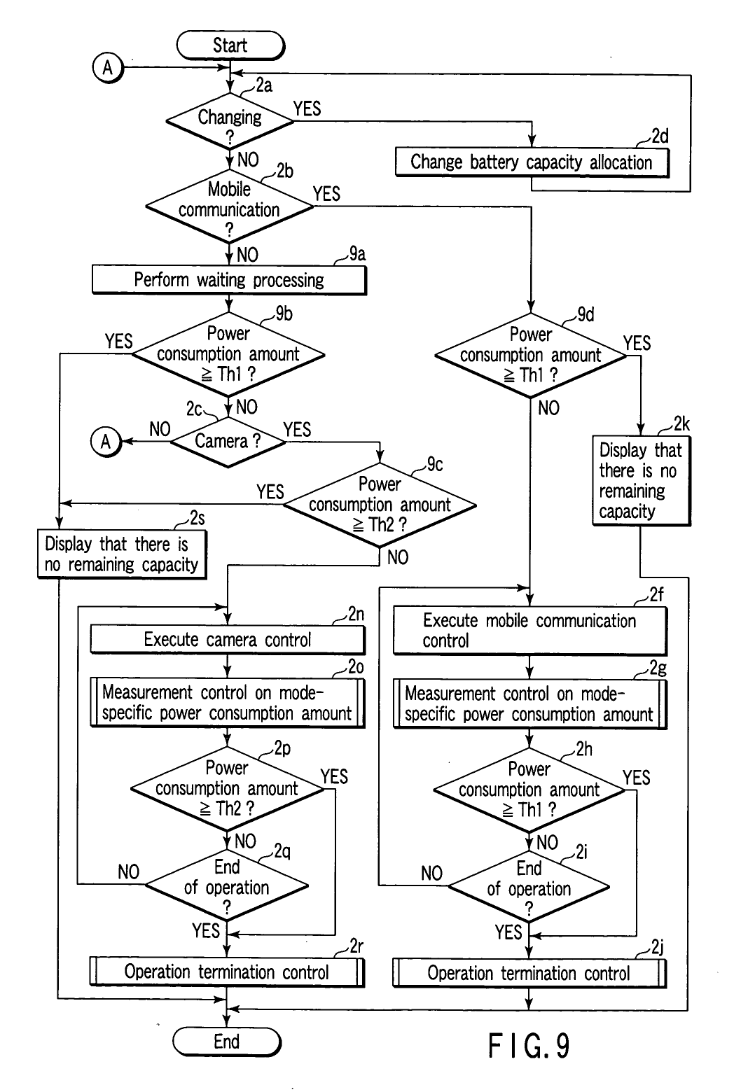

FIG. 9 is a flowchart showing a control sequence and control contents executed by the controller of the mobile telephone terminal according to the sixth embodiment of the present invention. The same reference numerals as in FIG. 2 denote the same parts in FIG. 9, and a detailed description thereof will be omitted. The basic arrangement of the terminal is the same as that shown in FIG. 1, and hence will be described with reference to FIG. 1.

The controller of the mobile telephone terminal monitors setting/changing operation for a mode-specific power supply capacity, operation for mobile communication, and operation for imaging by a camera 19 in steps 2a, 2b, and 2c, respectively, while performing incoming call waiting processing in step 9a.

Assume that a user has performed setting/changing operation for a mode-specific power supply capacity in this state. In this case, a controller 12A shifts the flow to step 2d to receive the setting/changing information input by the user through an input device 14. The controller 12A then changes the default values of the first and second capacities stored in the memory in the controller 12A in accordance with the received setting/changing information.

Assume that the user has performed outgoing call operation for telephone communication. In this case, the controller 12A shifts from step 2b to step 9d to compare a threshold Th1 with the cumulative power consumption amount of the first capacity allocated to the incoming call waiting mode and radio communication mode. The threshold Th1 is set in accordance with the allocation ratio between mode-specific power supply capacities previously changed in step 2d. If the cumulative power amount consumption amount is less than the threshold Th1, the flow shifts to step 2f to execute mobile communication control. In contrast, if the cumulative power consumption amount is equal to or more than threshold Th1, the controller 12A determines that mobile communication operation cannot be done because the first capacity allocated to the mobile communication mode has been used up. The flow then shifts to step 2k, in which the message “there is no remaining capacity” is displayed on a display device 15, together with an icon representing the mobile communication mode. The flow then shifts to the standby state.

After the incoming call waiting processing in step 9a, the controller 12A compares the cumulative power consumption amount of the first capacity with the threshold Th1 in step 9b. If the cumulative power consumption amount is less than the threshold Th1, the flow shifts to step 2c to monitor the imaging operation of the camera 19. Subsequently, the controller 12A repeatedly monitors the above setting/changing operation for a mode-specific power supply capacity (step 2a), operation for mobile communication (step 2b), incoming call waiting processing (step 9a), and the imaging operation of the camera 19 (step 2c) as long as the cumulative power consumption amount of the first capacity is less than the threshold Th1.

In contrast to this, assume that the cumulative power consumption amount of the first capacity becomes equal to or more than the threshold Th1. In this case, the controller 12A determines that the first capacity allocated to the mobile communication mode has already been used up, and shifts to step 2s, in which the message “there is no remaining capacity” is displayed on the display device 15, together with the icon representing the mobile communication mode. The flow then returns to the standby state.

Even after the mobile communication mode cannot be used, imaging operation can be done with the camera 19 if a sufficient battery capacity (second capacity) for the camera mode is left. When imaging operation by the camera 19 is performed, the controller 12A shifts to step 9c to compare the cumulative power consumption amount of the second capacity with a threshold Th2. If the cumulative power consumption amount is less than the threshold Th2, the flow shifts to step 2n to execute imaging/display control on the camera. FIG. 4 shows the control sequence and control contents.

Assume that the cumulative power consumption amount of the second capacity becomes equal to or more than the threshold Th2. In this case, the controller 12A determines that imaging/display operation by the camera 19 cannot be done because the second capacity allocated to the camera mode has already been used up. The flow then shifts to step 2s, in which the message “there is no remaining capacity” is displayed on the display device 15, together with the icon representing the camera mode. The flow then returns to the standby state.

As described above, according to the sixth embodiment, the first capacity is allocated to the incoming call waiting mode and radio communication mode to allow the use of the incoming call waiting mode and radio communication mode within the range of the first capacity. If, therefore, the first capacity is used up in the incoming call waiting state as well as by data communication such as speech communication and e-mail communication, the use of the mobile communication mode is disabled afterward.

Note that the sixth embodiment has exemplified the case wherein the first capacity is allocated to the incoming call waiting mode and radio communication mode, and the second capacity is allocated to the camera mode. However, the present invention is not limited to this; the first capacity may be allocated to the radio communication mode, and the second capacity is allocated to the incoming call waiting mode and camera mode.

### Other Embodiments

A mode-specific power supply controller preferably includes a correction unit which measures the initial capacity of a battery 16 or those of cells 16a and 16b and corrects thresholds Th1, Th2, Th3, and Th4 on the basis of the measured initial capacity of the battery 16 or those of the cells 16a and 16b. In general, the initial capacities of batteries often vary depending on the performance of the batteries, aging, charged states, and the like. Measuring the initial capacity of the battery 16 or those of the cells 16a and 16b and reflecting the value or values in the thresholds Th1, Th2, Th3, and Th4 can always allow accurate mode-specific power supply control regardless of the initial capacity of the battery 16 or those of the cells 16a and 16b.

The allocation ratio between the first and second capacities for the first and second modes may be adaptively and variably set in accordance with the operating times or frequencies of use of the first and second modes. For example, the operating times or frequencies of use of the first and second modes are monitored, and the ratio between the sums of operating times or the numbers of times of use of the first and second modes is calculated at predetermined time intervals. The allocation ratio between the first and second capacities is then adaptively and variably set in accordance with the calculated ratio between the sums of the operating times or the numbers of times of use. With this arrangement, the allocation ratio between the first and second capacities can be adaptively and variably set to an optimal value in accordance with the operating times or frequencies of use of the first and second modes by the user. This makes it unnecessary for the user to perform changing/setting operation for an allocation ratio.

If the first capacity is allocated to the mobile communication mode, the first capacity is further divided into the third and fourth capacities. The third and fourth capacities may be allocated to the incoming call waiting mode and radio communication mode, respectively. With this arrangement, the incoming call waiting mode and radio communication mode can be operated by independent battery capacities, respectively. As a consequence, even if, for example, the fourth capacity allocated to the radio communication mode runs out, the waiting mode can be operated alone as long as the third capacity is left. This makes it possible to continue registration of the position of the terminal.

Option modes to be subjected to mode-specific power supply control also include an execution mode for application programs such as games, a mode of detecting the current position of the mobile communication terminal by using a Global Positioning System (GPS) receiver and map data and displaying it, and the like. Note that the application program execution mode includes a mode of loading an application program such as a game from a storage medium such as a memory card or downloading a similar application program from a Web server.

The above embodiment has exemplified the mobile communication terminal using the CDMA scheme as a radio access scheme. However, the present invention can be applied to a mobile communication terminal using a time division multiple access (TDMA) scheme. As a radio interface, a wireless local area network (LAN) may be used. In addition, the type of mobile communication terminal to be used may include a portable notebook personal computer in addition to a mobile telephone terminal and PDA terminal.

In addition, the arrangement of the mobile communication terminal, the types of modes and their combination, the ratio between battery capacities allocated to the respective modes, the mode-specific power supply control sequence and its contents, and the like can be variously modified within the spirit and scope of the invention.

In other words, the present invention is not limited to the above embodiments, and constituent elements can be modified in execution stages without departing from the spirit and scope of the invention. In addition, various inventions can be realized by properly combining a plurality of constituent elements disclosed in the respective embodiments described above. For example, several constituent elements may be omitted from all the constituent elements in each embodiment. Furthermore, constituent elements in different embodiments may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A mobile communication terminal comprising:
a first mode unit which executes a first mode for mobile communication with a base station;
a second mode unit which executes a second mode different from the first mode;
a battery which outputs power for operating the first mode unit and the second mode unit; and
a mode-specific power supply control unit which divides a battery capacity held by the battery into a first capacity and a second capacity, and allocates the first capacity and the second capacity to the first mode unit and the second mode unit, respectively.

2. The terminal according to claim 1, wherein
the mode-specific power supply control unit comprises
a calculator which calculates a consumption amount of the first capacity from a power consumption and operating time of the first mode unit,
a comparator which compares the calculated consumption amount of the first capacity with a first threshold, and
a unit which limits supply of power to the first mode unit when the calculated consumption amount of the first capacity exceeds the first threshold.

3. The terminal according to claim 1, wherein
the mode-specific power supply control unit comprises
a calculator which calculates a consumption amount of the second capacity from a power consumption and operating time of the second mode unit,
a comparator which compares the calculated consumption amount of the second capacity with a second threshold, and
a unit which limits supply of power to the second mode unit when the calculated consumption amount of the second capacity exceeds the second threshold.

4. The terminal according to claim 2, wherein
the mode-specific power supply control unit further comprises
a measurement device which measures an initial capacity of a battery, and
a correction unit which corrects the first threshold on the basis of the measured initial capacity of the battery.

5. The terminal according to claim 3, wherein
the mode-specific power supply control unit further comprises
a measurement device which measures an initial capacity of a battery, and
a correction unit which corrects the second threshold on the basis of the measured initial capacity of the battery.

6. The terminal according to claim 1, wherein
the battery includes a plurality of cells, and
the mode-specific power supply control unit divides the battery into a first cell having a first capacity and a second cell having a second capacity, and supplies power output from the first cell and the second cell to the first mode unit and the second mode unit, respectively.

7. The terminal according to claim 1, wherein the mode-specific power supply control unit further comprises a unit which changes an allocation ratio of the first capacity for the first mode unit in accordance with input operation for setting information by a user.

8. The terminal according to claim 1, wherein the mode-specific power supply control unit further comprises a unit which changes an allocation ratio of the second capacity for the second mode unit in accordance with input operation for setting information by a user.

9. The terminal according to claim 1, wherein the mode-specific power supply control unit further comprises
a timer which measures an operating time in the first mode, and
a unit which adaptively and variably sets an allocation ratio of the first capacity for the first mode unit on the basis of the measured operating time.

10. The terminal according to claim 1, wherein the mode-specific power supply control unit further comprises
a counter which counts the number of times of use of the first mode, and
a unit which adaptively and variably sets an allocation ratio of the first capacity for the first mode unit on the basis of the counted number of times of use.

11. The terminal according to claim 1, wherein the mode-specific power supply control unit further comprises
a timer which measures an operating time in the second mode, and
a unit which adaptively and variably sets an allocation ratio of the second capacity for the second mode unit on the basis of the measured operating time.

12. The terminal according to claim 1, wherein the mode-specific power supply control unit further comprises
a counter which counts the number of times of use of the second mode, and
a unit which adaptively and variably sets an allocation ratio of the second capacity for the second mode unit on the basis of the counted number of times of use.

13. The terminal according to claim 1, further comprising
a unit which calculates and/or detects a remaining capacity of the first capacity, and
a unit which displays the calculated and/or detected remaining capacity of the first capacity in correspondence with the first mode unit.

14. The terminal according to claim 1, further comprising
a unit which calculates and/or detects a remaining capacity of the second capacity, and
a unit which displays the calculated and/or detected remaining capacity of the second capacity in correspondence with the second mode unit.

15. The terminal according to claim 13, further comprising
a comparator which compares the detected remaining capacity of the first capacity with a third threshold, and
a unit which, when the remaining capacity of the first capacity becomes lower than the third threshold, notifies a user of corresponding information in correspondence with the first mode unit.

16. The terminal according to claim 14, further comprising
a comparator which compares the detected remaining capacity of the second capacity with a fourth threshold, and
a unit which, when the remaining capacity of the second capacity becomes lower than the fourth threshold, notifies a user of corresponding information in correspondence with the second mode unit.

17. The terminal according to claim 1, wherein
the first mode unit comprises a third mode unit and a fourth mode unit which execute a third mode and a fourth mode which are different from each other, and
the mode-specific power supply control unit further comprises a control unit which further divides the first capacity into a third capacity and a fourth capacity, and allocates the third capacity and the fourth capacity to the third mode unit and the fourth mode unit, respectively.

18. The terminal according to claim 1, wherein
the second mode unit comprises a third mode unit and a fourth mode unit which are different from each other, and
the mode-specific power supply control unit further comprises a control unit which further divides the second capacity into a third capacity and a fourth capacity, and allocates the third capacity and the fourth capacity to the third mode unit and the fourth mode unit, respectively.
